(19) United States
(12) Patent Application Publication
(10) Pub. No.: US 2005/0006863 A1
(43) Pub. Date: Jan. 13, 2005

(54) Baby carriage with directional wheels that pivot in unison by semi-rigid means

(75) Inventor: Laurent Ageneau, Pornic (FR)

Correspondence Address: Robert M. Angus;Westman, Champlin & Kelly, Suite 1600, 900 Second Avenue South, Minneapolis, MN, 55402-3319, US

(73) Assignee: AMPAFRANCE, Cholet (FR)

(21) Appl. No.: 10/819,708

(22) Filed: Apr. 7, 2004

(30) Foreign Application Priority Data
Apr. 7, 2003 (FR) FR 03 04312

(51) Int. Cl. B62B 7/04

(52) U.S. Cl. 280/47.38

(57) ABSTRACT

A stroller of the type comprising at least one wheel on each side of the stroller, the axis of rotation of the wheel bearing coupled to a pivoting part on an element of the frame of the stroller, such that the wheels are directional. The stroller is characterized by semi-rigid means installed in tension between the pivoting parts and designed such that the directional wheels pivot in unison.

### FIELD OF THE INVENTION

This invention relates to the field of childcare. More precisely, the invention relates to baby carriages (referred to as “strollers” in the remainder of this description, which in this case includes all child care devices provided with wheels and used for the transport of one child or several children).

### BACKGROUND OF THE INVENTION

Strollers usually have four wheels or four wheel blocks, installed at the end of the legs of the stroller frame, or at the ends of a transverse axis installed free to rotate on the frame, particularly depending on the selected folding method.

To improve usage comfort, front wheels are proposed installed free to rotate on a vertical axis, so that they pivot and thus facilitate direction changes.

In practice, directional wheels of this type frequently introduce undesirable effects. Under the effect of uneven ground, the directional wheels may start an uncontrolled oscillating movement, which is unpleasant for the child and also for the person driving the stroller.

For example, a path with uneven ground can force the directional wheels into different orientations, which tends to cause shaking or disturb progress of the stroller.

Therefore, means have been proposed for locking each wheel in a fixed position, such that the directional wheels can be locked at an orientation corresponding to the stroller moving in a straight line.

However, it is not easy to use these means, since it is necessary to bend down in front of each front wheel, and the wheels are usually dirty.

Consequently, users usually leave the wheels in the fixed position (or in the free position) and do not benefit from the advantages resulting from the choice between the two positions, depending on the ground.

Another problem with known techniques is that the front wheels are completely independent, and consequently they are rarely parallel, particularly when the ground is uneven. Obviously, this does not facilitate progress and comfort.

The possibility of fixing the two wheels together has been envisaged, but this causes relatively complex and rigid systems, causing problems particularly for folding and for the ground clearance.

The purpose of the invention is to overcome these disadvantages according to prior art.

More precisely, the purpose of the invention is to propose a stroller equipped with efficient and easy-to-use directional wheels.

In particular, the purpose of the invention is to provide such a stroller with good stability, directional control, rolling qualities.

In this sense, the purpose of the invention is to provide such a stroller that avoids or significantly limits oscillating movements of the directional wheels and lack of parallelism.

Another purpose of the invention is to provide such a stroller that is easily and efficiently adapted and/or adaptable to different ground types.

Another purpose of the invention is to provide such a stroller with a large ground clearance.

Another purpose of the invention is to provide such a stroller that is easily and efficiently foldable.

In practice, directional wheels of this type frequently introduce undesirable effects. Under the effect of uneven ground, the directional wheels may start an uncontrolled oscillating movement, which is unpleasant for the child and also for the person driving the stroller.

For example, a path with uneven ground can force the directional wheels into different orientations, which tends to cause shaking or disturb progress of the stroller.

Therefore, means have been proposed for locking each wheel in a fixed position, such that the directional wheels can be locked at an orientation corresponding to the stroller moving in a straight line.

However, it is not easy to use these means, since it is necessary to bend down in front of each front wheel, and the wheels are usually dirty.

Consequently, users usually leave the wheels in the fixed position (or in the free position) and do not benefit from the advantages resulting from the choice between the two positions, depending on the ground.

Another problem with known techniques is that the front wheels are completely independent, and consequently they are rarely parallel, particularly when the ground is uneven. Obviously, this does not facilitate progress and comfort.

The possibility of fixing the two wheels together has been envisaged, but this causes relatively complex and rigid systems, causing problems particularly for folding and for the ground clearance.

The purpose of the invention is to overcome these disadvantages according to prior art.

More precisely, the purpose of the invention is to propose a stroller equipped with efficient and easy-to-use directional wheels.

In particular, the purpose of the invention is to provide such a stroller with good stability, directional control, rolling qualities . . .

In this sense, the purpose of the invention is to provide such a stroller that avoids or significantly limits oscillating movements of the directional wheels and lack of parallelism.

Another purpose of the invention is to provide such a stroller that is easily and efficiently adapted and/or adaptable to different ground types.

Another purpose of the invention is to provide such a stroller with a large ground clearance.

Another purpose of the invention is to provide such a stroller that is easily and efficiently foldable.

### SUMMARY OF THE INVENTION

These objectives, and others that will appear later, are achieved according to the invention using a stroller including at least two directional wheels or blocks of wheels, and semi-rigid means acting on the directional wheels or blocks of wheels, such that they pivot in unison.

This type of link between the directional wheels permit to avoid or at least considerably limit the possibility of them starting to oscillate under the effect of ground irregularities or uneven ground.

Moreover, semi-rigid means (such as cables or a belt) functioning in tension can be easily and quickly installed. This type of means creates an efficient, reliable and low cost result.

Note that in this case a distinction is made between the terms “link by semi-rigid means” and directional wheel systems linked by deformable parallelograms or other linkage systems using rigid parts, as is the case on some lightweight vehicles in fields other than in child care, for example as in carting.

These known systems usually form complex mechanical assemblies requiring adjustments during assembly.

In any case, these mechanical assemblies are not very compatible with the field of strollers that have to be lightweight and compact (particularly limiting the size in the rolling plane), flexible in use and reliable in the long term, particularly when they are used on grounds that could cause significant dirt accumulation.

According to one preferred solution, the directional wheels are fitted at the end of legs connected by a cross-piece that is remote from the axis of rotation of the directional wheels, at least upwards, the semi-rigid means extending between the pivoting parts running approximately along the legs and the cross-piece.

Unlike traditional strollers which conventionally have a cross-piece between the legs of the frame, this cross-piece is usually aligned with the axis of rotation of the directional wheels or close to it, thus significantly increasing the ground clearance of the stroller, enabling it to easily cross over small obstacles without needing to lift the stroller.

Advantageously, the wheels or the wheel blocks each have an axis of rotation coupled to a pivoting part on an element of the frame of the stroller, and the semi-rigid means are installed in tension between the semi-rigid means.

Preferably, the directional wheels are installed at the end of legs, the semi-rigid means running approximately along each of the legs, over a part of their length and extending approximately horizontally between the legs raised above the axis of the wheels or the wheel blocks.

According to one particular embodiment of the invention, the wheels or the wheel blocks are installed at the front of the stroller.

According to a first approach of the invention, the semi-rigid means advantageously include at least one cable.

In this case, the ends of the cable(s) may advantageously be fitted with at least one stud and each of the pivoting parts has at least one housing in which the stud will be fitted.

Preferably, the semi-rigid means comprise two cables mounted approximately in parallel on the pivoting parts such that the displacement of one of the cables in one direction causes displacement of the other of the cables in the opposite direction.

According to a second advantageous approach, the semi-rigid means can form a closed loop. Thus, the semi-rigid means can advantageously include at least one belt or a chain.

In particular, it may include at least one notched belt.

Preferably, the loop extends approximately horizontally between the pivoting parts.

Advantageously, the stroller comprises means of offsetting the loop above the maximum height of the wheels or the wheel blocks.

Thus, for example the pivoting parts may have an extension at the top of which there is a pinion or a pulley on which the loop is fitted.

According to another approach, the offsetting means can also include angle transmission means.

According to another advantageous characteristic of the invention, the semi-rigid means include shock-absorbing means for opposing shocks that could be applied to the directional wheels or wheel blocks.

Preferably, the shock absorbing means comprise means of increasing and/or reducing the length of the semi-rigid means.

The shock absorbing means may thus include return means.

In particular, in this case, it would be possible for the semi-rigid means to include at least two semi-rigid segments connected to each other by the return means.

According to another embodiment, in the case of cables, the cables can at least partly slide inside a duct. Advantageously, at least one of the ducts then at least partly forms the shock absorbing means.

According to another advantageous characteristic of the invention, the stroller includes means of locking/unlocking the directional function of the wheels or wheel blocks, such that they remain parallel to the rolling axis of the stroller.

The locking/unlocking means can thus include an element fixed to the frame and inside which at least one locking part is fitted free to move between a position in which it cooperates with a housing provided in the pivoting part to prevent it from turning, and a retracted position in which the pivoting part can turn freely.

According to one particular embodiment, the locking part is activated by a mobile ramp inside the element fixed to the frame.

Advantageously, the profile of the ramp is adapted such that locking of the wheels can be disengaged if the mechanism is forced beyond a predetermined threshold.

In particular, the locking part may be a ball.

Preferably, the ramp cooperates with a compression spring tending to bring it into the locking position when the locked position is selected.

According to one advantageous approach, the locking/unlocking means act on the semi-rigid means.

According to another advantageous characteristic, it would be possible that the semi-rigid means circulate at least partly inside an element of the frame of the stroller.

In particular, the semi-rigid means can circulate inside a part of the legs and/or the handlebar of the stroller.

In this case, the stroller may comprise a lock/unlock control fitted on the handlebar acting on the semi-rigid means circulating inside the handlebar.

Advantageously, the locking/unlocking means mentioned above are remotely controlled using control means.

The control means may thus comprise a control lever fitted on the handlebar of the stroller. The lever is preferably connected to the ramp by at least one cable.

Preferably, the handlebar has at least two means of retaining the lever, the two retaining means being separated from each other to enable a change from the locked position to the unlocked position, or vice versa, when the lever moves from one retaining means to the other.

Advantageously, the retaining means are cutouts made in the wall of a sleeve fixed to the handlebar.

Advantageously, these cutouts are provided on the sleeve (91) such that the lever must be turned by a quarter of a turn to change from one cutout to the next.

According to yet another advantageous aspect of the invention, the axis of rotation of the directional wheels is supported by a main bearing installed free to rotate on the pivoting part about an approximately horizontal axis, and suspension means are provided between the main bearing and the pivoting part.

### BRIEF DESCRIPTION OF THE DRAWINGS

Other characteristics and advantages of the invention will appear more clearly after reading the following description of a preferred embodiment of the invention given as an illustrative and non-limiting example, and the attached drawings among which:

FIGS. 1, 2 and 3 are perspective, front and top views respectively of the part of the frame fitted with directional wheels according to the invention;

FIG. 4 is a detailed view of the directional system of a stroller wheel according to the invention;

FIGS. 5, 6 and 7 are diagrammatic views of semi-rigid link means connecting the directional wheels according to the invention, the wheels being in the straight position, in the turned position and in a shock situation respectively;

FIG. 8 is an exploded view of the directional system of a stroller wheel according to the invention;

FIG. 9 is a sectional view of locking/unlocking means of a directional wheel according to the invention;

FIG. 10 is a perspective view of a control lever for the locking/unlocking means of a stroller directional wheel according to the invention;

FIG. 11 illustrates another embodiment of the invention, using a notched belt, the front wheels being viewed from above;

FIG. 12 shows a wheel in the system in FIG. 11, and means of activating it by the belt.

### DETAILED DESCRIPTION OF THE PREFERRED EMBODIMENTS

As mentioned above, the principle of the invention consists of fixing the directional wheels of a stroller together in pivoting using semi-rigid means (for example cables) fitted in tension between these wheels.

Note that the directional wheels of a stroller are usually at the front of this stroller. However, the principle according to the invention could be applied to a stroller fitted with directional wheels at the back.

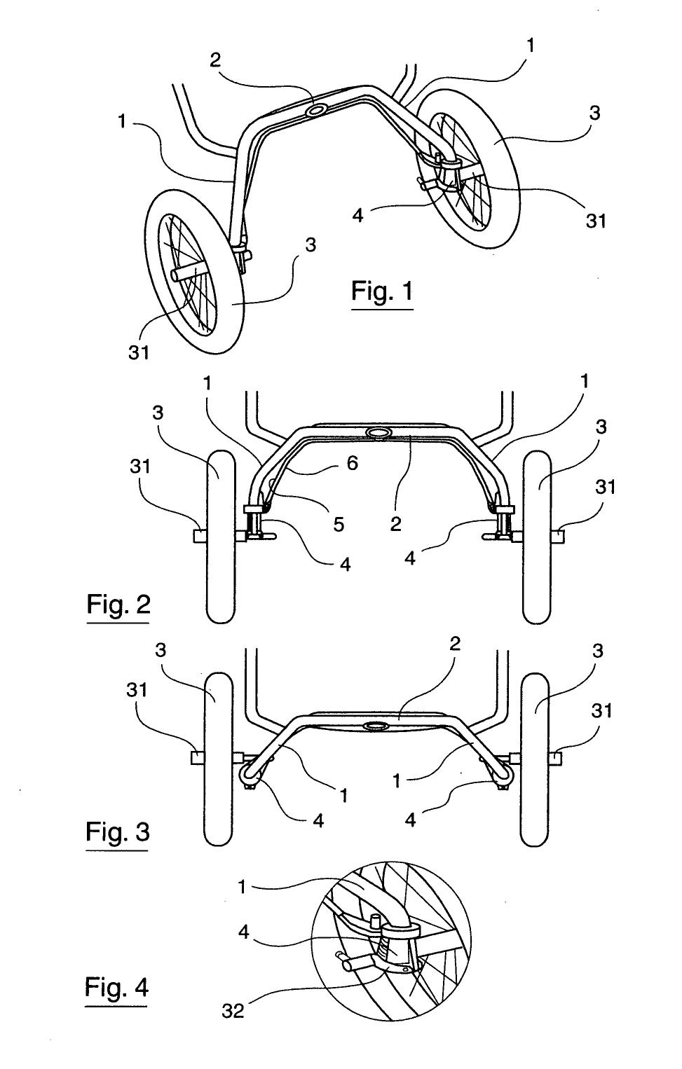

With reference to FIGS. 1 to 4, according to this embodiment the frame of a stroller includes legs 1 connected to each other by a crosspiece 2.

As illustrated in FIGS. 1 to 3, the legs 1 and the cross-piece 2 together form an inverted U extending essentially in a vertical plane such that the cross-piece 2 is relatively remote from the axis of rotation 31 of the wheels 3. According to the invention, there is no need for the wheels to be connected by a rigid axle.

The axis of rotation 31 of the wheels 3 is supported by main bearings 32, installed free to rotate on a connecting part 4 around an axis 41.

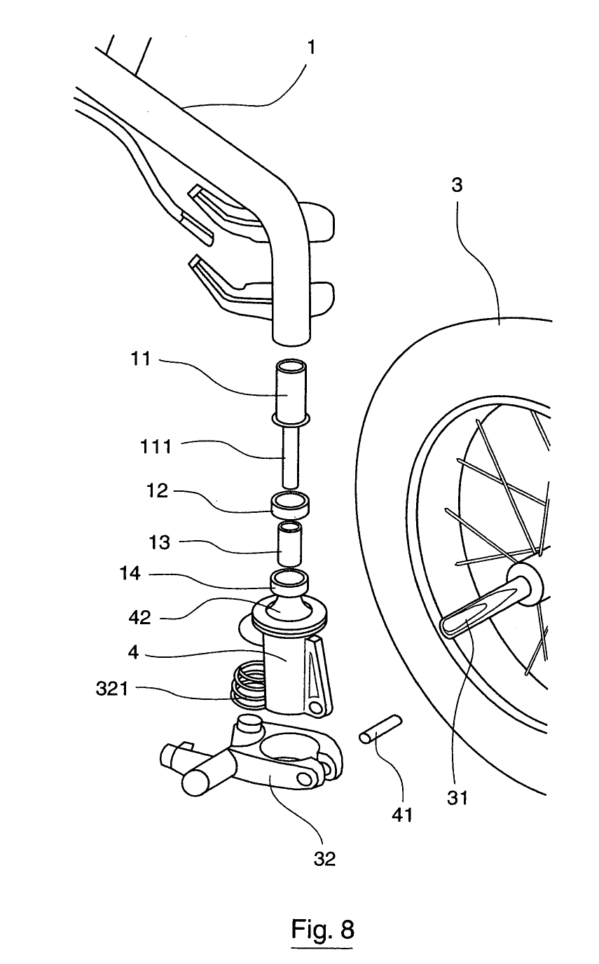

Note that a helical spring 321 forming suspension means is inserted between the bearing 32 and the connecting part 4. This aspect is discussed in the following in relation to FIG. 8.

The connecting parts 4, denoted as “pivoting parts” in the remainder of the description, are installed free to rotate at the free ends of the legs 1 using a mechanical assembly formed by:
a plug 11;
a first bearing 12;
a spacer 13;
a second bearing 14.

The rod 111 of the plug 11, the spacer 13 and the bearings 12 and 14 fit into the central housing in the pivoting part 4, as illustrated in the exploded view in FIG. 8.

According to the invention, semi-rigid means, in this case two cables 5, 6 are installed in tension between the pivoting parts 4 such that the directional wheels pivot in unison.

As can be seen clearly in FIGS. 1 and 2, the cables 5 and 6 extend between the pivoting parts 4 running along the assembly formed by the legs 1 and the crosspiece 2.

Therefore, it can be understood that with such an arrangement, the ground clearance of a stroller according to the invention can be considerably improved.

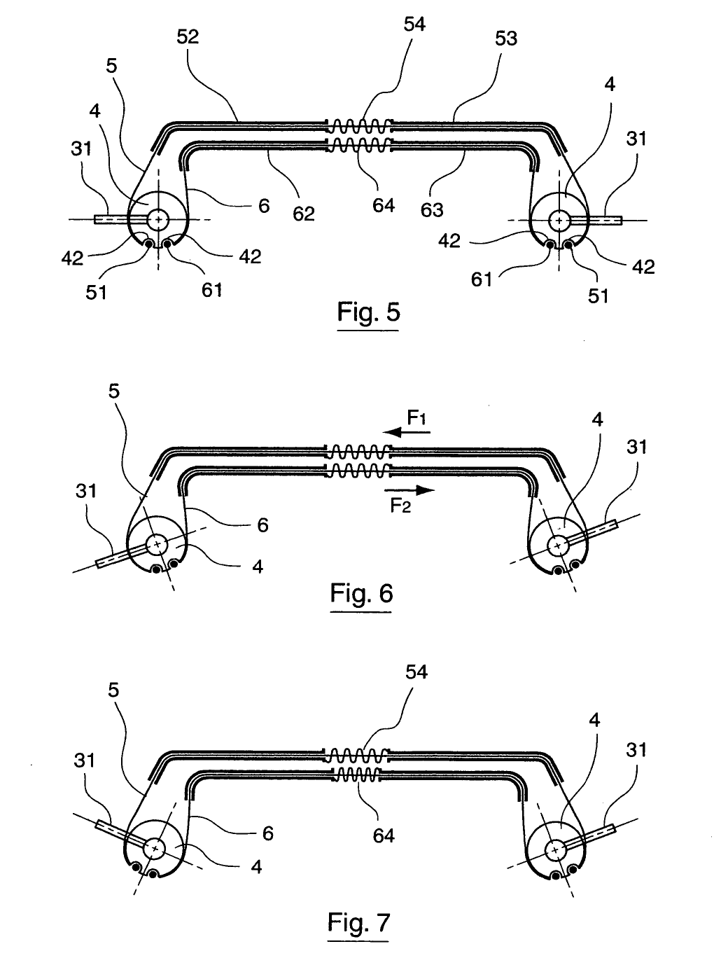

The principle of the connection between the pivoting parts 4 will now be described in detail with reference to FIGS. 5 and 7.

As illustrated in these Figures, the cables 5 and 6 are each fitted with a stud 51 and 61 respectively at each of their ends, that fit into housings 42 formed in the pivoting parts 4.

These cables 5 and 6 form a discontinuous loop around the pivoting parts 4 such that movement of one of the cables in one direction causes the other cable to move in the opposite direction. This is illustrated in FIG. 6: considering a rotation of the pivoting parts 4 in the counter-clockwise direction, the cable 5 moves in the direction indicated by the arrow F1, while cable 6 moves in the direction indicated by arrow F2.

In this embodiment, each of the cables 5, 6 consists of two segments, which slides are guided by ducts 52, 53 and 62, 63 respectively, these segments being connected to each other respectively by return means, in this case springs 54 and 64, forming shock absorbing means as will be explained later.

With reference to FIG. 7 that illustrates a situation in which a shock or pressure (or other) causes opposing rotations of pivoting parts 4, the springs 54 and 64 act so as to prevent the cables from breaking and/or from disengaging from their housings at their ends.

In the case illustrated, the spring 54 works in traction and enables an increase of the space separating the two segments of the cable 5, thus increasing the distance separating the two ends of the cable 5.

Conversely, the spring 64 works in compression and reduces the space separating the two segments of the cable 6, thus reducing the distance between the two ends of the cable 6.

Obviously the opposite case (spring 54 in compression and spring 64 in traction) would also be possible.

Note that the stiffness of the springs 54 and 64 is adjusted such that the shock absorbing function of the springs is reserved for the type of situation illustrated in FIG. 7, and that these springs 54 and 64 do not work in compression or in traction (or as little as possible) when the orientation of the directional wheels is changed, illustrated as an example in FIG. 6.

Note also that the springs 54 and 64 are preferably placed along the crosspiece 2 of the frame, approximately at mid-distance between the wheels.

According to another embodiment of the invention, this shock absorbing function may be performed directly by the ducts, making use of the elasticity of the ducts. The assembly is thus simplified, since in this case there are then only two ducts and two cables passing through each of the corresponding ducts.

According to another approach to the invention, the cable(s), either passing or not passing through a duct, can circulate at least partly inside elements of the frame (and particularly the legs).

This (these) cable(s) could also pass afterwards through the handlebar, such they are completely concealed. This approach would also make it possible to define new functions, related to the presence of semi-rigid elements at the handlebar, for example for locking the directional wheels in a fixed position, or for providing an indicator about the position of the wheels (for example in the form of a needle connected to one of the cables). The junction and shock absorption could also be done at this level.

According to another aspect of the invention, means could be provided for locking the directional wheels in the fixed position.

This principle is known in itself. However, the known technique for this purpose is not very practical.

Therefore, according to one characteristic of the invention, it is possible for a control of these locking means to be fitted on the handlebar.

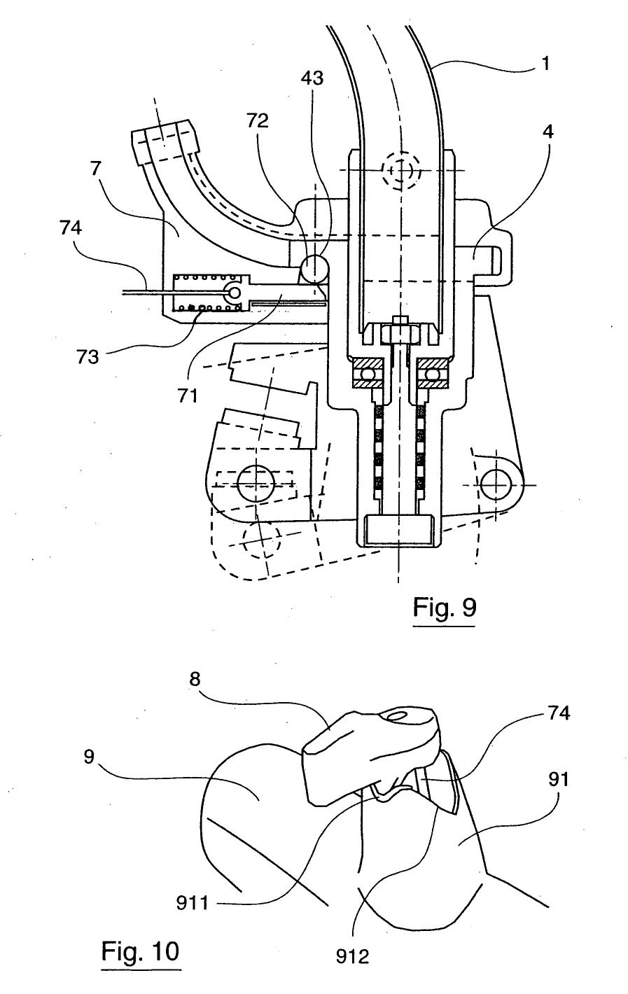

These locking means are illustrated in FIG. 9. They include a pin 71, the end of which forms a ramp and a ball 72 forming a means of locking the pivoting part 4 in a position in which the wheels are parallel to the stroller rolling axis.

Pin 71 can slide inside an element 7 fixed to the leg 1. When this pin 71 slides towards the right in FIG. 9, the ramp formed at its end pushes the ball 72 upwards, into a hemispherical housing 43 formed for this purpose in the pivoting part 4, thus locking this pivoting part in rotation.

Conversely, when the pin 71 slides sufficiently far towards the left in FIG. 9, the ball 72 drops under the effect of gravity and is therefore completely released from the housing 43 of the pivoting part, such that this part is free to rotate.

Note that the pin 71 cooperates with a spring 74 that tends to bring the pin 71 into its locking position when the locked position is selected.

Note also that the ramp profile can advantageously be chosen such that the wheel locking is “disengageable”, in other words the locking system is released from the locked position if a force exceeding a predetermined threshold is applied to it. This avoids risks of damage.

For example, this profile may be convex or it may be formed of at least two inclined planes with different angles.

According to one variant, the ball 72 could be eliminated. In this case, the pin or shuttle 71 is in direct contact with the housing 43 of the part 4. The shapes of the pin and the housing are complementary. In particular they may have a square, rectangular or round cross-section.

Moreover, the pin 71 is activated by means of a cable 74 and is remote controlled using control means including a lever 8 accessible from a handlebar of the stroller.

This lever 8 and its method of cooperating with the handlebar of the stroller are illustrated in FIG. 10.

According to this embodiment, the lever 8 is accessible from the handlebar 9 of the stroller, the handlebar having a sleeve 91 with means of retaining the lever 8 and through which the cable 74 extends connecting the lever 8 to the pin 71.

The sleeve 91 comprises cutouts 911 and 912 forming retaining means for the lever 8. As can be seen clearly, the cutout 912 is deeper than cutout 911.

Thus, when the lever fits into the cutout 912, the cable is released over a sufficient distance so that the spring 73 activates the pin 71 putting it into a position in which it brings the ball 72 into the locking position.

Conversely, when the lever 8 is in the cutout 911, the cable is pulled such that the pin 71 releases the ball 72 from the housing 43 of the pivoting part 4.

Note that cutouts 911 and 912 are provided on the sleeve 91 such that the lever moves from one to the other, particularly by making a quarter turn.

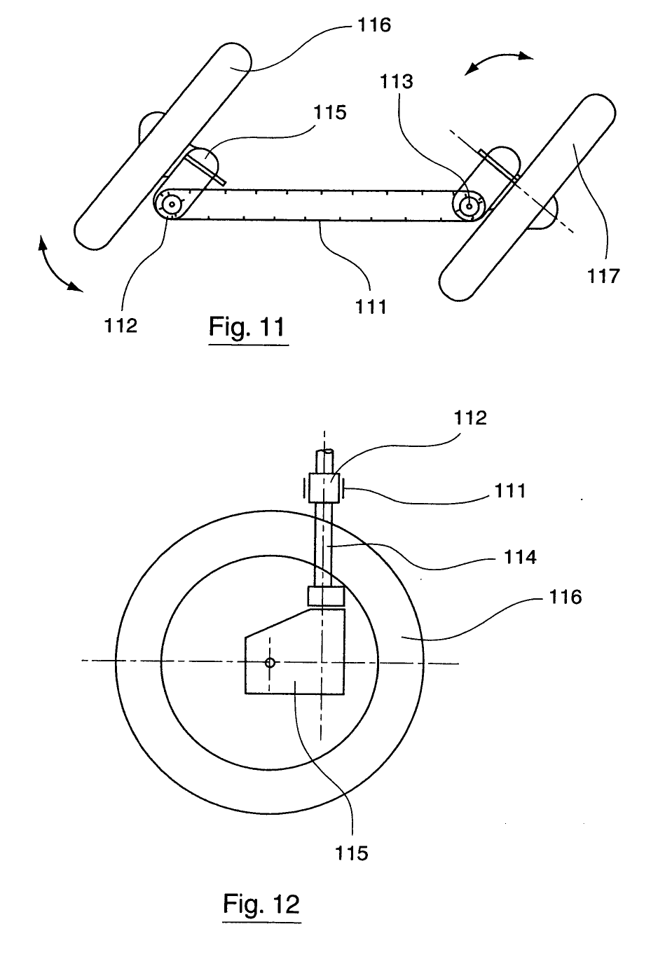

FIGS. 11 and 12 illustrate another embodiment of the invention, according to which the semi-rigid means form a closed loop. This loop may be a cable, a chain or a belt.

In the example in FIG. 11, a notched belt 111 circulates between two gear wheels 112 and 113 installed on the top part of an extension 114 (FIG. 12) fixed to the pivoting element 115 on which the wheel 116 is mounted, and lies along the vertical direction.

The gear wheels 112 and 113 are thus positioned above the level of wheels 116 and 117. Therefore these wheels can pivot by 360°, and can possibly turn several times in the same direction without any limit stop or other limitation.

If it is impossible or undesirable to provide this type of extension 114, angle transmission systems (pinion, pulleys or others) may be provided to keep this 360° rotation function.

The optional aspects presented above (particularly for locking) may be applied to this embodiment.

Although the present invention has been described with reference to preferred embodiments, workers skilled in the art will recognize that changes may be made in form and detail without departing from the spirit and scope of the invention.

1. Stroller comprising at least two directional wheels or wheel blocks, characterized in that it comprises semi-rigid means acting on the directional wheels or wheel blocks, such that they pivot in unison.

2. Stroller according to claim 1, characterized in that the wheels or the wheel blocks each have an axis of rotation coupled to a pivoting part on an element of the frame of the stroller, and in that the semi-rigid means are installed in tension between the semi-rigid means.

3. Stroller according to claim 1, characterized in that the directional wheels are installed at the end of legs, the semi-rigid means running approximately along each of the legs over a part of their length and extending approximately horizontally between the legs raised above the axis of the wheels or the wheel blocks.

4. Stroller according to claim 1, characterized in that the wheels or the wheel blocks are installed at the front of the stroller.

5. Stroller according to claim 1, characterized in that the semi-rigid means include at least one cable.

6. Stroller according to claim 5, characterized in that the ends of the cable(s) are fitted with at least one stud and in that each of the pivoting parts has at least one housing in which the stud will be fitted.

7. Stroller according to claim 5, characterized in that the semi-rigid means comprise two cables mounted approximately in parallel on the pivoting parts such that the displacement of one of the cables in one direction causes displacement of the other of the cables in the opposite direction.

8. Stroller according to claim 1, characterized in that the semi-rigid means form a closed loop.

9. Stroller according to claim 8, characterized in that the semi-rigid means include at least one belt or a chain.

10. Stroller according to claim 9, characterized by the inclusion of at least one notched belt.

11. Stroller according to claim 8, characterized in that the loop extends approximately horizontally between the pivoting parts.

12. Stroller according to claim 8, characterized by means of offsetting the loop above the maximum height of the wheels or the wheel blocks.

13. Stroller according to claim 11, characterized in that the pivoting parts have an extension at the top of which there is a pinion or a pulley on which the loop is fitted.

14. Stroller according to claim 12, characterized in that the offsetting means include angle transmission means.

15. Stroller according to claim 1, characterized in that the semi-rigid means include shock-absorbing means for opposing shocks that could be applied to the directional wheels or wheel blocks.

16. Stroller according to claim 15, characterized in that the shock absorbing means comprise means of increasing and/or reducing the length of the semi-rigid means.

17. Stroller according to claim 15, characterized in that the shock absorbing means include return means.

18. Stroller according to claim 17, characterized in that the semi-rigid means include at least two semi-rigid segments connected to each other by the return means.

19. Stroller according to claim 5, characterized in that the cable(s) slide at least partly inside a duct.

20. Stroller according to claim 19, characterized in that the semi-rigid means include shock-absorbing means for opposing shocks that could be applied to the directional wheels or wheel blocks and that at least one of the ducts at least partly forms the shock absorbing means.

21. Stroller according to claim 1, characterized by means of locking/unlocking the directional function of the wheels or wheel blocks, such that they remain parallel to the rolling axis of the stroller.

22. Stroller according to claim 21, characterized in that the locking/unlocking means include an element fixed to the frame and inside which at least one locking part is fitted free to move between a position in which it cooperates with a housing provided in the pivoting part to prevent it from turning, and a retracted position in which the pivoting part can turn freely.

23. Stroller according to claim 22, characterized in that the locking part is activated by a mobile ramp inside the element fixed to the frame.

24. Stroller according to claim 23, characterized in that the profile of the ramp is adapted such that locking of the wheels can be disengaged if the mechanism is forced beyond a predetermined threshold.

25. Stroller according to claim 22, characterized in that the locking part is a ball.

26. Stroller according to claim 23, characterized in that the ramp cooperates with a compression spring tending to bring it into the locking position when the locked position is selected.

27. Stroller according to claim 22, characterized in that the locking/unlocking means act on the semi-rigid means.

28. Stroller according to claim 1, characterized in that the semi-rigid means circulate at least partly inside an element of the frame of the stroller.

29. Stroller according to claim 28, characterized in that the semi-rigid means circulate inside a part of the legs and/or the handlebar of the stroller.

30. Stroller according to claim 29, characterized in that the semi-rigid means circulate at least partly inside an element of the frame of the stroller and a lock/unlock control fitted on the handlebar acting on the semi-rigid means circulating inside the handlebar.

31. Stroller according to claim 22, characterized in that the locking/unlocking means are remotely controlled using control means.

32. Stroller according to claim 31, characterized in that the control means comprise a control lever fitted on the handlebar of the stroller.

33. Stroller according to claim 31, characterized in that the lever is connected to the ramp by at least one cable.

34. Stroller according to claim 32, characterized in that the handlebar has at least two means of retaining the lever, the two retaining means being separated from each other to enable a change from the locked position to the unlocked position, or vice versa, when the lever moves from one retaining means to the other.

35. Stroller according to claim 34, characterized in that the retaining means are cutouts made in the wall of a sleeve fixed to the handlebar.

36. Stroller according to claim 35, characterized in that the cutouts are provided on the sleeve such that the lever must be turned by a quarter of a turn to change from one cutout to the next.

37. Stroller according to claim 1, characterized in that the axis of rotation of the directional wheels is supported by a main bearing installed free to rotate on the pivoting part around an approximately horizontal axis, and in that suspension means are provided between the main bearing and the pivoting part.
